(19) United States
(12) Patent Application Publication
(10) Pub. No.: US 2015/0353147 A1
(43) Pub. Date: Dec. 10, 2015

(54) ASSEMBLY FOR TENSIONING A CABLE AND METHOD OF USING THE SAME

(71) Applicant: CABLE MANUFACTURING & ASSEMBLY, INC., Bolivar, OH (US)

(72) Inventor: Eric M. Bernhardt, Akron, OH (US)

(21) Appl. No.: 14/729,496

(22) Filed: Jun. 3, 2015

Related U.S. Application Data
(60) Provisional application No. 62/007,669, filed on Jun. 4, 2014.

(51) Int. Cl. B62D 33/037; B23P 11/00

(52) U.S. Cl. CPC B62D 33/037; B23P 11/005

(57) ABSTRACT

A spring clip for use with a cable eyelet, a cable assembly incorporating the spring clip and a method of using the spring clip to bias a cable attached to the cable eyelet toward a fastener extending outwardly from a structure. The fastener is received through an aperture in the cable eyelet. The cable eyelet is itself secured to an end of the cable. The cable eyelet, defines an aperture therein and the aperture receives the fastener therethrough. The spring clip includes a first region that is securable to the cable eyelet and a second region extending outwardly from the first region in a direction opposite to the cable. The hook-shaped second region is configured to engage the head of the fastener and to bias the cable toward the fastener thus reducing the tendency of the cable to appear slack.

### CROSS-REFERENCE TO RELATED APPLICATIONS

This application claims the benefit of U.S. Provisional Application Ser. No. 62/007,669, filed Jun. 4, 2014, the entire specification of which is incorporated herein by reference.

### BACKGROUND OF THE INVENTION

1. Technical Field

The present invention relates to a cable assembly. More particularly, the present invention relates to a cable assembly for use in ensuring an associated cable is sufficiently tensioned while secured to a support structure. Specifically, the present invention relates to providing a cable assembly having a biasing member secured to a first end of a cable for maintaining tension on the cable through a range of displacement on the second end of the cable.

2. Background Information

Cables are used in a variety of fields to securely hold and support components. For example, heavy duty cables may be used to suspend duct systems and raceways in plants or factories or may be used to suspend bridges or cable cars. Lighter duty cables may be utilized to perform functions like supporting a tailgate on a truck so that the tailgate may adequately hold a load being moved thereover. Wherever they are used cables need to be placed under an appropriate tension in order to perform properly. Too much tension and the integrity of the cable may be compromised. Too little tension and the cable may not be able to perform the task for which it was installed.

As indicated above, lighter duty cables may aid in supporting a pickup truck's tailgate when in an open position and while goods are being moved across the tailgate during loading or unloading. Typically, a pair of cables is used to perform this task with the cables being secured to opposite ends of the tailgate. A first end of each cable is secured to one of the sidewalls of the truck box and the second end is secured to the tailgate. Tailgate cables are typically installed between the d-pillar of the truck box and the top of the tailgate. Neither the cable lengths nor the attachment points used for securing the cables are adjustable.

Variations in the manufacturing of truck pickup boxes may result in one of the tailgate cables appearing to be slack when the tailgate is in the open position while the other tailgate cable appears to be taut. This disparity may lead a consumer to conclude that there is a defect in one of the cables or in the tailgate or in the pickup box when this is actually not the case. Even if one cable appears to be slack and the other cable appears taut, the cables are still effective at supporting loads moved thereacross. However, this may not be the consumer's perception and they may therefore be unhappy with the truck they have purchased.

### BRIEF SUMMARY

There is therefore a need in the industry for a way to place a pickup truck tailgate cable under the correct tension or to adjust the tension if needed and thereby tend to reduce slackness and/or the appearance of slackness in the cable. One such cable tensioning assembly for lighter duty cables is disclosed herein.

Disclosed herein is a spring clip for use with a cable eyelet, a cable assembly incorporating the spring clip and a method of using the spring clip to bias a cable attached to the cable eyelet toward a fastener extending outwardly from a structure. The fastener is received through an aperture in the cable eyelet. The cable eyelet is itself secured to an end of the cable. The cable eyelet, defines an aperture therein and the aperture receives the fastener therethrough. The spring clip includes a first region that is securable to the cable eyelet and a second region extending outwardly from the first region in a direction opposite to the cable. The hook-shaped second region is configured to engage the head of the fastener and to bias the cable toward the fastener thus reducing the tendency of the cable to appear slack.

The addition of tension to the cable through use of the tensioning assembly will tend not to impact the integrity of the cable and will not tend to reduce the size of the load that the cables can support.

In one aspect, the invention may provide a spring clip for use with a cable eyelet that is secured to an end of a cable, where the cable eyelet defines an aperture therein and the aperture receives a fastener therethrough, wherein the fastener extends outwardly from a structure; and wherein the spring clip comprises a first region adapted to be secured to the cable eyelet; and a second region extending outwardly from the first region in a direction opposite to the cable; and wherein the second region is adapted to engage the fastener and to bias the cable toward the fastener.

In another aspect, the invention may a cable assembly comprising a cable having a first end and a second end; a first connector secured to the first end of the cable; an opening defined by the connector and adapted to selectively surround a fastener extending outwardly from a structure to which the cable is to be secured; and a second connector secured to the first connector, wherein the second connector is adapted to abut the fastener when the fastener is surrounded by the opening and the second connector biases the cable towards the fastener when so engaged.

In another aspect, the invention may provide a method of attaching and tensioning a cable to a structure; said method comprising the steps of providing a cable assembly having a first connector and a second connector; securing the first connector of the cable assembly to a first end of the cable; securing the second connector to the first connector; surrounding a first portion of a fastener extending outwardly from the structure with the first connector; and abutting a second portion of the fastener with the second connector to bias the cable towards the fastener.

### BRIEF DESCRIPTION OF THE SEVERAL VIEWS OF THE DRAWINGS

A sample embodiment of the invention is set forth in the following description, is shown in the drawings and is particularly and distinctly pointed out and set forth in the appended claims.

FIG. 1 is a front view of a rear end of a truck box showing a first end of a cable secured to a sidewall of the truck and tensioned by way of the cable tensioning assembly in accordance with an aspect of the present invention;

FIG. 2A is a front view of a first PRIOR ART cable eyelet securing a first end of a cable to a fastener extending inwardly from the sidewall of a truck box;

FIG. 2B is a front view of a second PRIOR ART cable eyelet securing a first end of a cable to a fastener extending inwardly from the sidewall of a truck box;

FIG. 3 is an enlarged front view of the highlighted region of the cable tensioning assembly shown in FIG. 1 and in accordance with an aspect of the present invention;

FIG. 3A is an enlarged front view of the highlighted region shown in FIG. 3;

FIG. 4 is a front view of the first end of the cable with the cable tensioning assembly separated from the fastener on the sidewall of the truck box;

FIG. 5 is an exploded perspective view of the first connector and of the cable tensioning assembly;

FIG. 6 is a side view of the cable tensioning assembly;

FIG. 7 is a top view of the cable tensioning assembly;

FIG. 8 is a side view of the first connector, the first end of the cable and the cable tensioning assembly taken along line 8-8 of FIG. 3;

FIG. 9 is a cross-sectional view of the first connector, the first end of the cable and the cable tensioning assembly taken along line 9-9 of FIG. 3;

FIG. 10 is a front view of the first connector, the first end of the cable and the cable tensioning assembly tensioning the cable.

Similar numbers refer to similar parts throughout the drawings.

### DETAILED DESCRIPTION

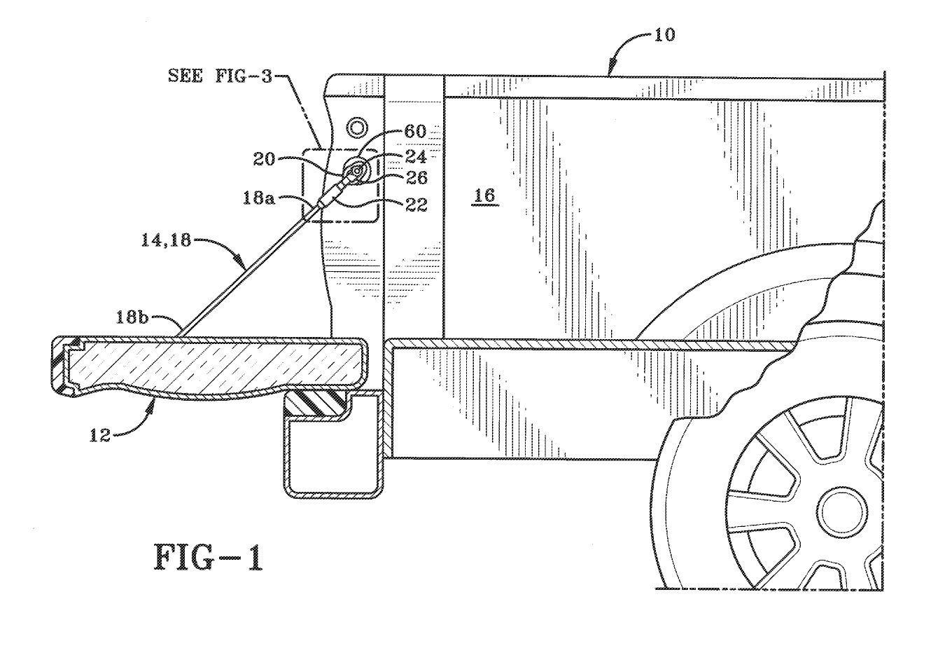

FIG. 1 is a view of a truck box 10, a tailgate 12, and a cable assembly 14 that secures tailgate 12 to a sidewall 16 of truck box 10. The view shown in FIG. 1 is referred to herein as being a front view and all subsequent views are therefore described with reference to this orientation of the components of the cable assembly 14.

Various non-novel features found in the prior art relating to cable manufacture are not discussed herein. The reader will readily understand the fundamentals of cable manufacture and fabrication are well within the prior art and readily understood by one familiar therewith.

Cable assembly 14 broadly includes a first connector secured to a first end of a cable and a second connector secured to the first connector. More particularly, cable assembly 14 includes a cable 18, a first connector, namely, cable eyelet 20 and sleeve 22; and a second connector in the form of a cable tensioning assembly which engages the cable eyelet 18 and sleeve 22.

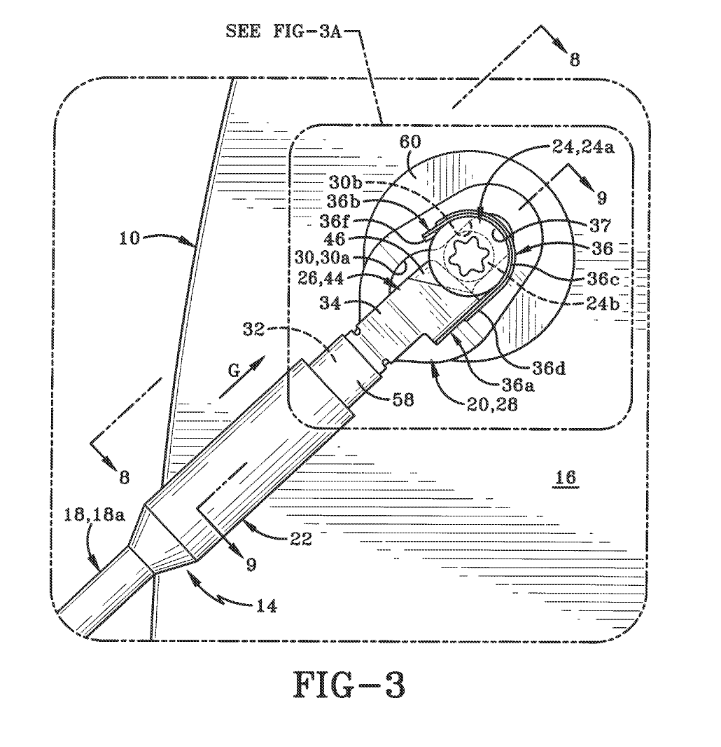

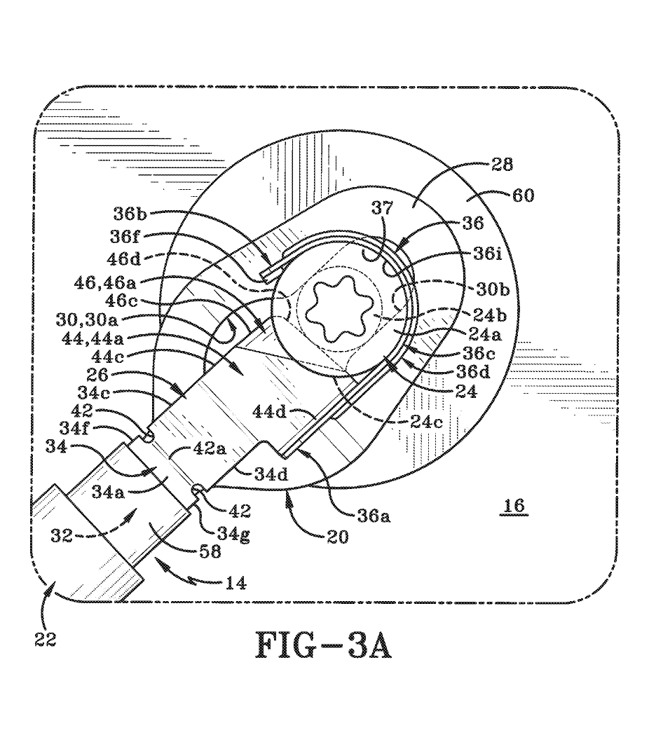

Cable 18 has a first end 18a and a second end 18b. First end 18a is secured to sidewall 16 and second end 18b is secured to tailgate 12. Cable assembly 14 is used to connect first end 18a of cable 18 to sidewall 16 and to increase the tension in cable 18 to a degree sufficient to reduce slackness in cable 18. The first connector comprises cable eyelet 20 and sleeve 22 where sleeve 22 is used to connect first end 18a of cable 18 to cable eyelet 20. Cable eyelet 20, in turn, engages a fastener 24 extending outwardly from an inner surface of sidewall 16. In accordance with an aspect of the present invention, the second connection, i.e., the cable tensioning assembly, may comprise a spring clip 26 (FIG. 3) which engages the first connector and the fastener 24. These various components will be discussed in greater detail later herein.

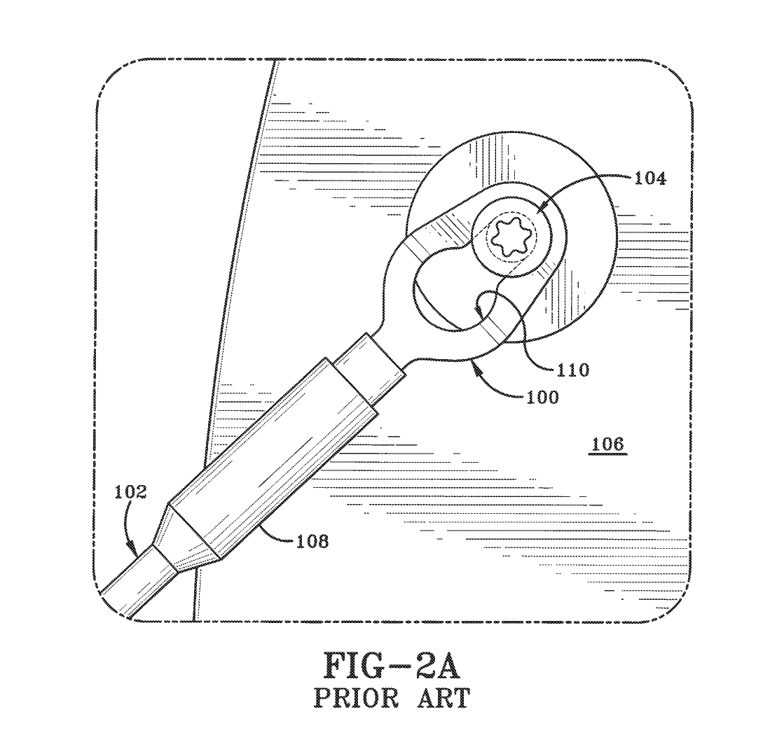

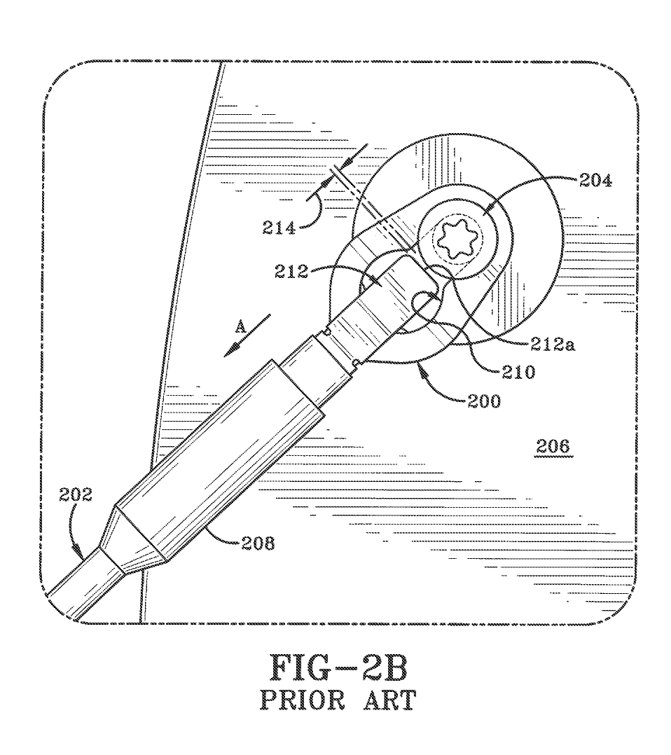

FIGS. 2A and 2B show two PRIOR ART cable assemblies that have been used in the industry to secure tailgate cables to fasteners extending outwardly from an inner surface of a sidewall of a truck body. These PRIOR ART cable assemblies include cable eyelets that do not apply sufficient tension to reduce the appearance of slackness in the cable which they attach to the truck sidewall. FIG. 2A shows a first PRIOR ART cable eyelet 100 that secures a cable 102 to a fastener 104 extending outwardly from a sidewall 106 of a truck box. The first end of cable 102 extends through a bore (not shown) in a sleeve 108 and sleeve grips the first end or is secured in some known manner thereto. Sleeve 108 also engages a base region of cable eyelet 100. Cable eyelet 100 comprises a plate that defines an aperture 110 therein. The plate is positioned so that a head of fastener 104 will pass through aperture 110. The plate may be oriented at a slight angle relative to sleeve 108 so that it is easier to cause the plate to capture fastener 104 in aperture 110. If the aperture 110 is keyhole-shaped then the plate of cable eyelet 100 is first moved relative to fastener 104 so that the shaft of that fastener 104 moves from a wider region of the aperture 110 to a narrower region thereof.

Once the fastener shaft is captured in aperture 110 the head thereof extends at least partially across an exterior surface of the plate of cable eyelet 100. Fastener 104 is then rotated to secure the plate of cable eyelet 100 against sidewall 106. In this PRIOR ART cable assembly the tension in cable 102 is determined by the position at which the fastener head or a washer used in conjunction with the fastener head contacts the plate of cable eyelet 100.

FIG. 2B shows a second embodiment of a PRIOR ART cable eyelet 200 which secures a cable 202 to a fastener 204 extending from a sidewall 206 of a truck box. In this instance, the cable eyelet 200 comprises a plate that defines an aperture 210 therein that is substantially similar to the plate and aperture of cable eyelet 100. The plate of cable eyelet 200 is positioned so that a head of fastener 204 will pass through aperture 210. Sleeve 108 is modified to include a limiting member 212 which extends outwardly therefrom in a direction opposite to the cable. The limiting member 212 extends across a region of aperture 210 in the plate of cable eyelet 200. As illustrated in FIG. 2B, the terminal end 212a of limiting member 212 is located so that it is in the wider region of aperture 210. In order to engage fastener 204, limiting member 212 has to be flexed away from the cable eyelet's plate.

Once through aperture 210, fastener 204 is rotated to secure the plate of cable eyelet 200 against sidewall 206. Tension in cable 202 is determined by the position at which the fastener head or an annular flange used therewith contacts the plate of cable eyelet 200. Tension in cable 202 is additionally determined by the position of an end 212a of limiting member 212 relative to the fastener head. As illustrated in FIG. 2B a gap 214 is defined between the head of fastener 204 and end 212a. When cable 202 is pulled in the direction of arrow “A” as the tailgate opens, the degree to which the eyelet 200 might move is dictated by the size of gap 214. Consequently, the possibility for slackness in the cable 202 is somewhat controlled by limiting member 212 but the cable assembly tends to still result in one or both cables 202 appearing slack to the eye.

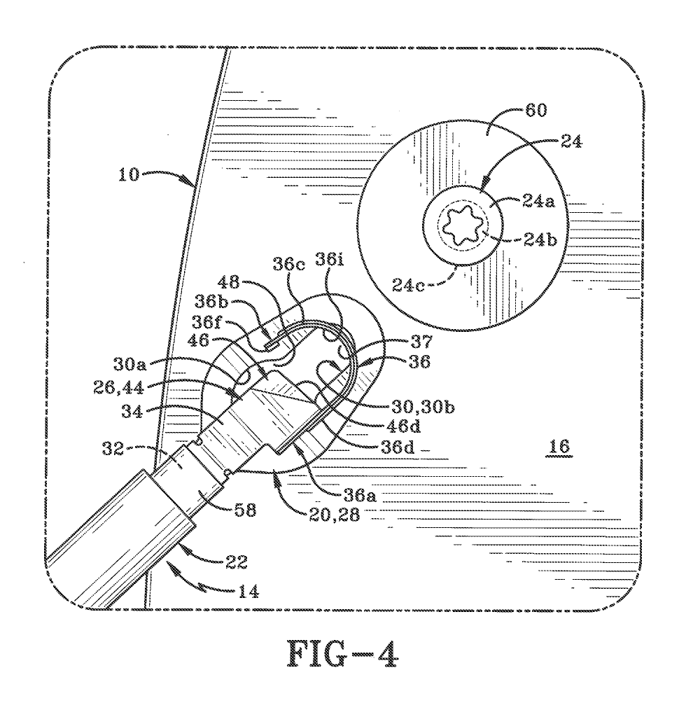

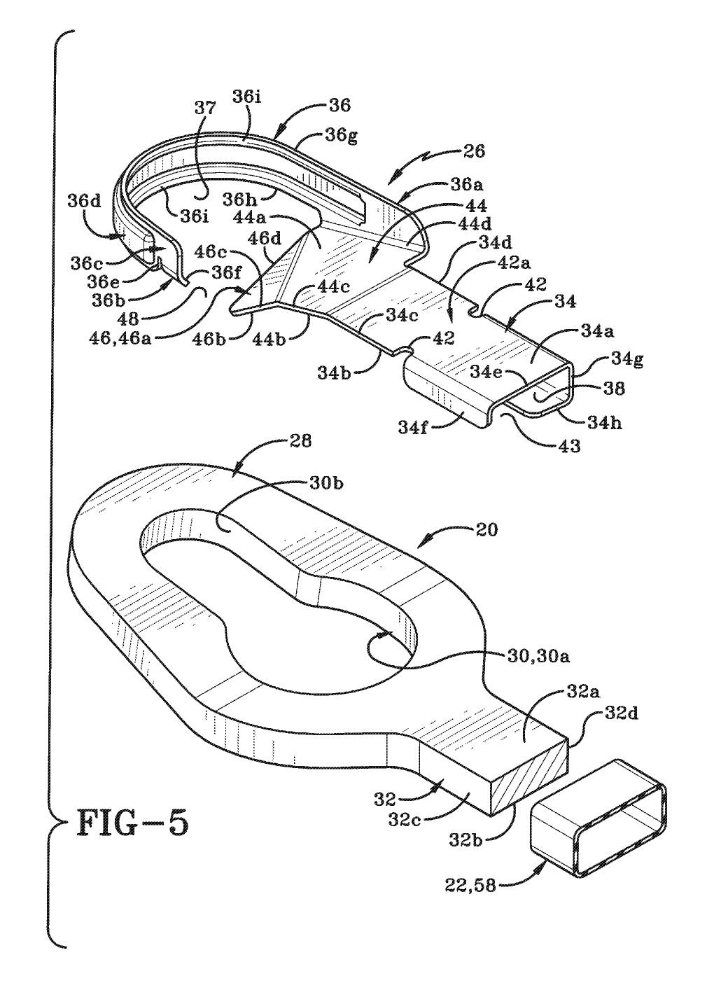

Referring now to FIG. 1 and FIGS. 3-10 the cable assembly 14 in accordance with an aspect of the present invention is discussed in greater detailed. As indicated previously herein, a first end 18a of cable 18 is secured to sleeve 22. FIG. 5 shows the cable eyelet 20 of cable assembly 14. Cable eyelet 14 includes a plate 28 which may define a keyhole-shaped aperture 30 therein. (Differently shaped plates or apertures may be utilized instead of the plate 28 and aperture 30 illustrated herein.) Aperture 30 is sized to allow head 24a of fastener 24 to pass therethrough. Aperture 30 is also sized to surround a portion of the shaft 24b of fastener 24. The orientation of the engaged portion of shaft 24b within aperture 30 generally secures cable assembly 14 to fastener 24 as any pulling or movement of cable 18 results in the plate 28 of the first connector (cable eyelet 14) abutting the portion of the shaft and thereby preventing cable 18 from moving away from fastener 24.

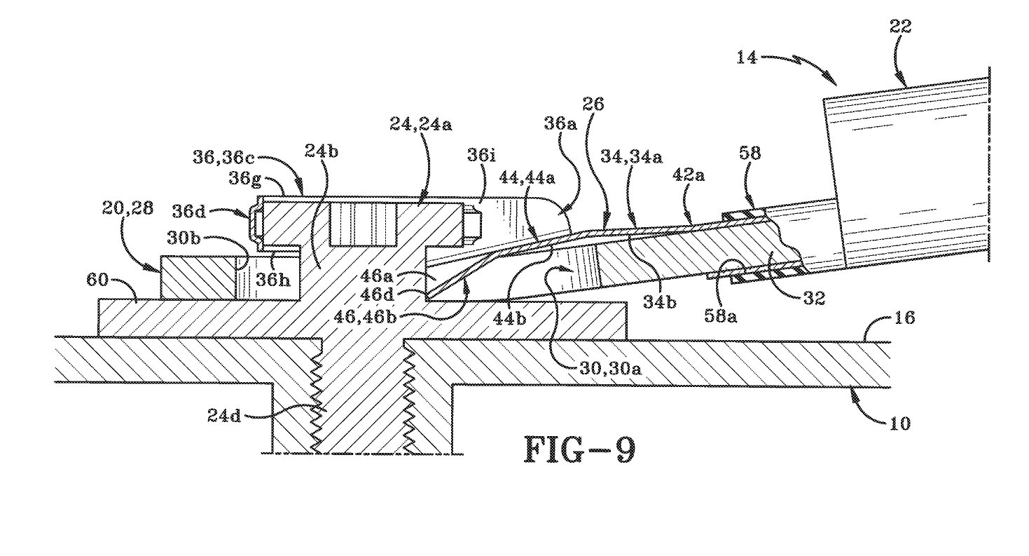

Since aperture 30 is a keyhole-shaped aperture, the aperture in includes a wider region 30a and a narrower region 30b. Plate 28 includes a shaft 32 which extends outwardly in a first direction from that part of plate 28 which defines wider region 30a of aperture 30. Shaft 32 has a first surface 32a, a second surface 32b, a first side 32c, and a second side 32d. An extension 58 (FIG. 3) on sleeve 22 defines a bore 58a (FIG. 9) therein which is complementary is shape and size to a portion of shaft 32. Spring clip 26 is positioned to surround at least a portion of shaft 32 and is also captured with shaft 32 within bore 58a. Spring clip 26 and shaft 32 may be retained within bore 58a by friction or may be gripped, crimped, clamped or secured by fasteners to sleeve 22. Any suitable way of securing sleeve 22 to plate 28 may be utilized.

Cable assembly 14 also includes a spring clip 26 in accordance with an aspect of the present invention. Spring clip 26 is engaged with shaft 32 on eyelet 20 proximate the extension 58 of sleeve 22. Spring clip 26 is engaged with cable eyelet 20 in such a way that at least a portion thereof extends across aperture 30. Like the PRIOR ART (FIG. 2B), spring clip 26 includes a first part which extends across wider region 30a of aperture 30. However, unlike the PRIOR ART, spring clip 26 includes a second part which extends across narrower region 30b and particularly across an end portion of narrower region 30b proximate the end of plate 28 which is remote from cable 18.

Spring clip 26 includes a base 34, a plate 44 and a biasing member. Biasing member may take the form of a hook 36. The biasing member, i.e., hook 36, is biased such that when hook 36 abuts head 24a of fastener 24, cable 18 is biased towards fastener 24. This configuration increases tension along the length of cable 18 and acts to hold cable 18 in a more taut orientation along the length of cable 18. Inasmuch as first end 18a of cable 18 is biased in the direction of fastener 24, any minor change in the placement of a second end 18b of cable 18 generally does not introduce any or much slack into the length of cable 18.

Hook 36 may be of any desired shape such as being generally J-shaped. Base 34 engages shaft 32 adjacent extension 58. Plate 44 extends outwardly from base 34 and hook 36 extends outwardly from plate 44. Hook 36 runs substantially the entire length of keyhole-shaped aperture 30, extends across narrower region 30b aperture 30 proximate outermost end of plate 20 and then curves back toward wider region 30a. Hook 36 terminates a short distance from plate 44 as will be described later herein.

It will be understood that spring clip 26 may be fabricated from a single planar piece of sheet metal that is stamped and bent into the shape illustrated in the attached figures. The portions of spring clip 26 identified as “base 34”, “plate 44, and “hook 36” are identified in this manner simply for ease of description in this document and should not be considered as limiting the structure of this cable tensioning assembly. It will further be understood that spring clip 26 may be fabricated out of a number of separate pieces that are subsequently welded or otherwise joined together.

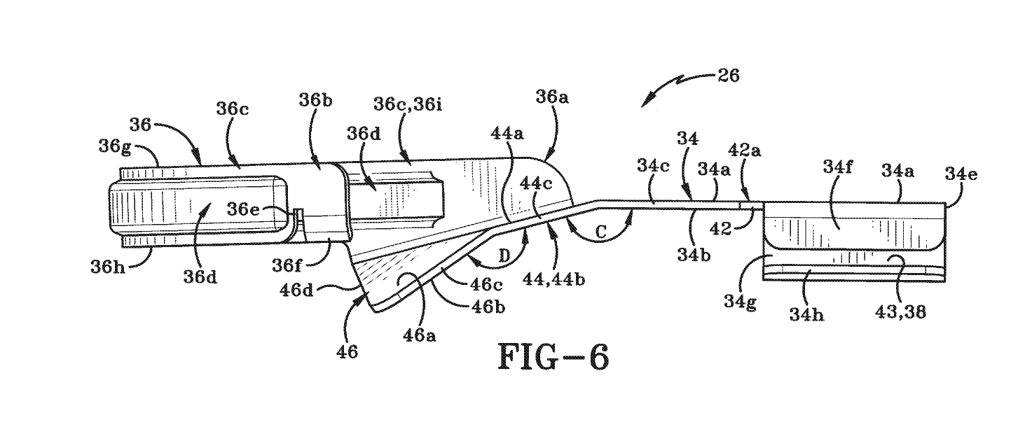

Base 34 comprises a generally rectangular region having a first surface 34a, a second surface 34b, a first edge 34c, a second edge 34d and an end 34e. Proximate end 34e, a first flange 34f extends outwardly from first edge 34c and is bent relative thereto. First flange 34f may be oriented at about 90 degrees relative to first surface 34a. A second flange 34g extends outwardly from second edge 34d and is bent relative thereto. First and second flanges 34f, 34g are opposed and extend downwardly from second surface 34b and are provided to lock spring clip 26 to shaft 32 of cable eyelet 20. First and second flanges 34f, 34g may frictionally engage shaft 32 or may be crimped or otherwise secured thereto. Second flange 34g is longer than first flange 34f (as shown in FIG. 6) and includes a leg 34h which is bent through about 90 degrees relative thereto. Leg 34h extends toward first flange 34f. A space 38 is defined between second surface 34b and an interior surface of leg 34h and between first and second flanges 34f, 34g. A gap 43 is also defined between an edge of leg 34h and first flange 34f. Gap 43 and space 38 are provided to enable spring clip 26 to be engaged with cable eyelet 20.

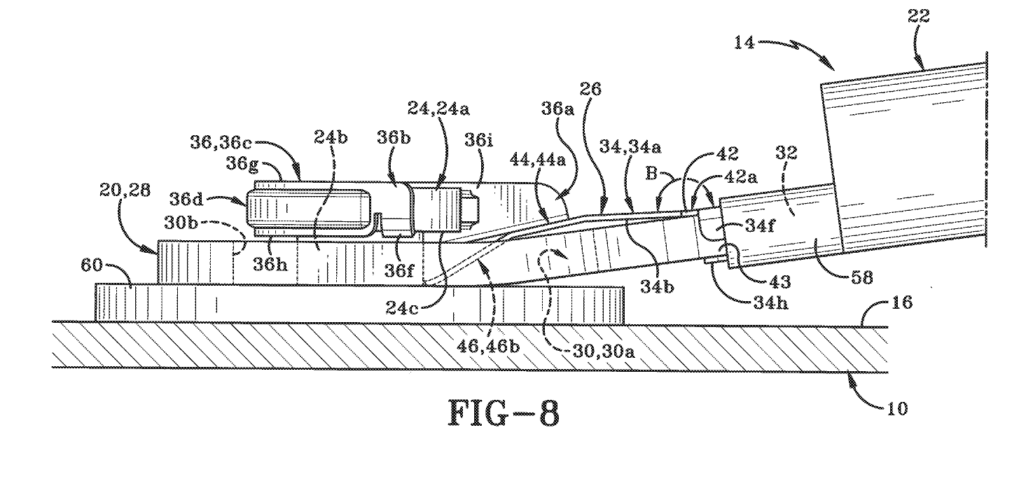

Base 34 further defines a pair of notches 42 in first and second edges 34c, 34d adjacent one end of each of first and second flanges 34f, 34g. As shown in FIG. 8, base 34 includes a bending region 42a which extends laterally between notches 42. Bending region 42a is disposed generally at right angles relative to longitudinal axis “Y” of spring clip 26. The bending region 42a permits a first part of base 34 to be oriented at an angle “B” (FIG. 8) relative to a second part of the base 34. Angle “B” may be from about one degree up to about 5 degrees, and preferably may be about three degrees.

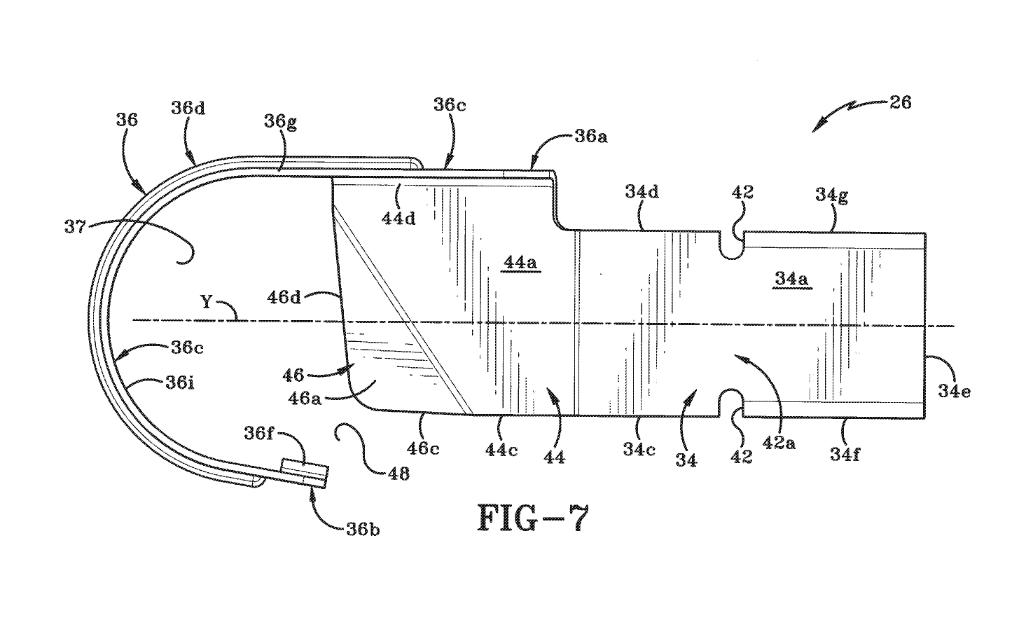

Plate 44 extends outwardly from a portion of base 34 remote from flanges 34f, 34g. Plate 44 has a first surface 44a, a second surface 44b, a first edge 44c, and a second edge 44d. FIG. 7 shows that first edge 44c is aligned with first edge 34c of base 34. Second edge 44d is generally parallel to and spaced a distance laterally outwardly from second edge 34d of base 34. As best seen in FIG. 6 or 8, plate 44 and base 34 are not aligned along a common plane. Instead, plate 44 is oriented at an angle “C” relative to base 34. As shown in FIG. 6, angle “C” may be from about one degree up to about 5 degrees, and preferably may be about three degrees.

Plate 44 includes a corner region 46 having a first surface 46a, a second surface 46b, a first edge 46c and a first end 46d. First edge 46c of corner region 46 is aligned with first edge 44c and first edge 34c (FIG. 7). First end 46d of corner region is located generally at 90°±10° relative to longitudinal axis “Y”. Corner region 46 may also be oriented at an angle “D” relative to the rest of plate 44. This is illustrated in FIG. 6. FIG. 6 shows that if base 34 is oriented generally horizontally, then plate 44 angles downwardly from one end of base 34 and corner region 46 angles downwardly from plate 44. Angle “D” may be from about one degrees up to about 5 degrees. Preferably, angle “D” is around 3 degrees.

Hook 36 extends outwardly from plate 44 and particularly from along second side 44d thereof. Second side 44d forms a bottom end of a first end 36a of hook 36. Hook 36 may be generally J-shaped with the straight leg of that J-shaped being generally aligned with second side 44d of plate 44. The curved region of hook 36 is longitudinally spaced from plate 44 but is generally aligned with plate. H Hook 36 has a terminal end 36b which is separated from corner region 46 by a gap 48. Terminal end 36b is located a distance laterally outwardly beyond aligned first edges 46c, 44c and 34c. Terminal end 36b is along longitudinally spaced a distance away from first end 46d. Hook 36 further includes a protrusion 36c which extends outwardly from an outer surface of hook 36. The protrusion 36c acts as a strengthening rib on hook 36. A slit 36d is defined in hook proximate terminal end 36b. Slit 36d originates in lower edge 36h and extends vertically upwardly for a distance. Part of terminal end 36b is bent inwardly and upwardly to form a decent 36e which may slightly latch onto a bottom edge of the head of fastener 24 (as will be later described. Hook 36 also includes an upper edge 36g, a lower edge 36h, and an inner surface 36i. As best seen in FIG. 7, a space 37 is defined between inner surface 36i of hook 36 and corner region 46d of plate 44. Inner surface 36i of hook 36 will abut head 24a of fastener 24 when shaft 24b of fastener 24 is received in narrower region 30b of aperture 30.

The cable tensioning assembly in accordance with an aspect of the present invention is used in the following manner. Spring clip 26 is engaged with cable eyelet 20 by inserting base 34 over shaft 32. This may be accomplished by positioning spring clip 26 such that part of shaft 32 enters the gap 43 between the edge of leg 34h and first flange 34f. The part of the shaft 32 slides into space 38 and then shaft 32 with base 34 of spring clip 26 engaged therewith is inserted into bore 58a of sleeve 22 and is retained therein by any suitable means.

As discussed earlier, fastener 24 extends outwardly from an inner surface of sidewall 16 of truck box 10. Fastener 24 (as shown in FIG. 9) may include a head 24a, with a bottom edge 24c, a shaft 24b which extends outwardly beyond bottom edge 24c, and a threaded end 24c which is engage able in a threaded hole in sidewall 16. Fastener may further include an annular flange 60 which is of a larger diameter than shaft 24b and the threaded hole in sidewall 16. Flange 60 abuts sidewall and circumscribes the threaded hole. Alternatively, instead of flange 60, a loose washer could be utilized. Cable eyelet 20 is positioned so that fastener head 24a passes through wider region 30a of the keyhole-shaped aperture 30. Base 34 and part of plate 44 may be deflected outwardly away from the plate 28 of cable eyelet 20 as head 24a enters aperture 30. Additionally, the positioning of cable eyelet 20 must be such as to not enable hook 36 to stop head 24a from entering wider region 30a. As discussed with reference to the PRIOR ART cable eyelets 100, 200, the plate of cable eyelet 20 may be oriented at an angle relative to sleeve 22 so that the plate 28 may more readily be positioned to capture fastener 24 in wider region 34a.

Once head 24a of fastener 24 enters wider region 30a of aperture 30, cable eyelet 20 is moved to slide shaft 24b of fastener 24 into narrower region 30b of aperture 30. This motion brings inner surface 36c of hook 36 into contact with the exterior surface of head 24a of fastener 24. Detent 36f on hook may somewhat engage the bottom edge 24c of head 24a. Corner region 46 of plate 44 may extend partially or fully into wider region 30a of aperture as is illustrated in FIG. 8 and come into contact with the exterior surface of fastener shaft 24b.

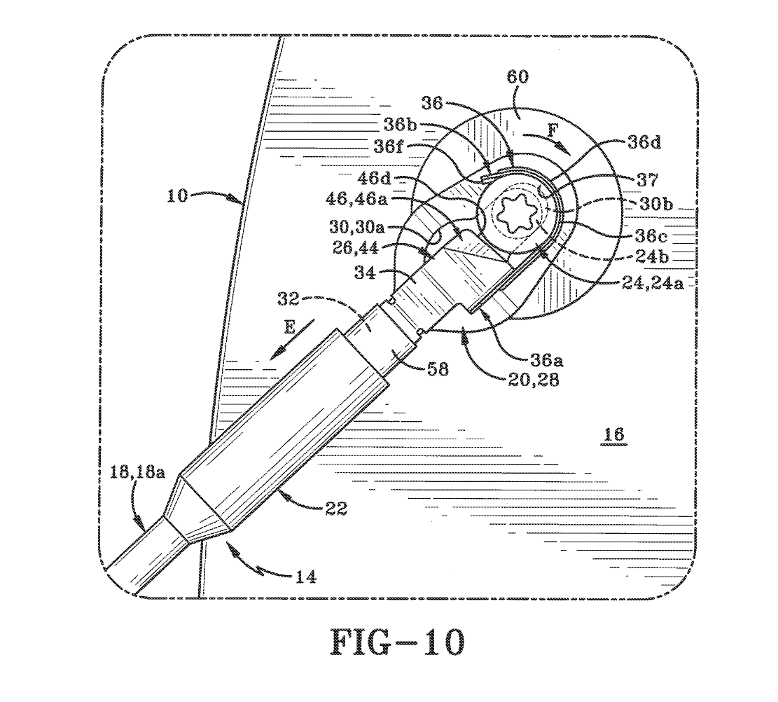

As tailgate 12 is moved from the closed position to the open position, cable 18 is pulled in the direction indicated by arrow “E” in FIG. 10. This motion causes the sleeve 22 and therefore extension 58 and shaft 32 of cable eyelet 20 to move in the direction of arrow “E”. Since base 34 of spring clip 26 is engaged with shaft 32, as shaft 32 moves in the direction of arrow “E”, a pulling force is exerted on the rest of spring clip 26. This motion causes rotational motion in parts of hook 36 in the direction of arrow “F” thus drawing hook 36 into closer contact with head 24a of fastener 24. Hook 36 and fastener 24 are thus more closely associated with each other. Every applied force causes an equal and opposite reaction. Thus, in response to the pulling on cable 18 in the direction of arrow “E” (FIG. 10) and equal and opposite pulling force is exerted by spring clip 26 on sleeve 22 and thereby on cable 18. This opposite pulling force is indicated by arrow “G” in FIG. 3. Thus, cable 18 is pulled taut. The size of the force does not have to be particularly large to pull cable 18 taut. About 7 lbs of tension may be generated in cable 18. The displacement between when the cable eyelet 20 is in a relaxed condition and when the cable is fully under tension utilizing spring clip 26 is about 6 mm. The use of cable tensioning assembly, i.e., spring clip 26, presents an aesthetically pleasing orientation of cable 18 and portrays that cable 18 is perfectly sized to fit between the fastener 24 and tailgate 12.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration set out herein are an example and the invention is not limited to the exact details shown or described.

1. A spring clip for use with a cable eyelet that is secured to an end of a cable, where the cable eyelet defines an aperture therein and the aperture receives a fastener therethrough, wherein the fastener extends outwardly from a structure; and wherein the spring clip comprises:
a first region adapted to be secured to the cable eyelet; and
a second region extending outwardly from the first region in a direction opposite to the cable; and wherein the second region is adapted to engage the fastener and to bias the cable toward the fastener.

2. The spring clip as defined in claim 1, wherein the second region includes a hook and the hook is adapted to engage the fastener.

3. The spring clip as defined in claim 2, wherein the second region further includes a base member that is linearly aligned with the hook; and wherein the base member is secured to the first region.

4. The spring clip as defined in claim 3, wherein the base member includes a base with a first wall having an inner surface that abuts an exterior surface of the first region; and the base member further includes a first flange extending outwardly from one side of the first wall and a second flange extending outwardly from an opposite second wall, and wherein the first and second flanges capture part of the first region therebetween.

5. The spring clip as defined in claim 4, wherein the base member further comprises a plate extending linearly outwardly from one end of the base; and wherein the plate is oriented at an angle relative to the base.

6. The spring clip as defined in claim 5, wherein the angle is from about two degrees up to about five degrees.

7. The spring clip as defined in claim 5, wherein the hook extends outwardly from the plate.

8. The spring clip as defined in claim 5, further comprising a corner region provided on the plate, wherein the corner region is adapted to engage a shaft of the fastener and the hook is adapted to engage a head of the fastener.

9. The spring clip as defined in claim 8, wherein the corner region is oriented at an angle relative to the rest of the plate.

10. The spring clip as defined in claim 1, wherein the hook includes a terminal end having a detent which angles inwardly into a space defined by an inner surface of the hook, and wherein the inner surface of the hook is adapted to contact an exterior surface of the head and the detent is adapted to contact a bottom edge of the head of the fastener.

11. The spring clip as defined in claim 1, wherein the hook includes a reinforcing rib extending outwardly from an exterior surface of the hook

12. The spring clip as defined in claim 11, wherein the hook is J-shaped and the rib follows the J-shaped curvature of the hook.

13. A cable assembly comprising:
a cable having a first end and a second end;
a first connector secured to the first end of the cable;
an opening defined by the connector and adapted to selectively surround a fastener extending outwardly from a structure to which the cable is to be secured; and
a second connector secured to the first connector, wherein the second connector is adapted to abut the fastener when the fastener is surrounded by the opening and the second connector biases the cable towards the fastener when so engaged.

14. The cable assembly as defined in claim 13, wherein the second connector includes a biasing member and the biasing member is hook-shaped.

15. The cable assembly as defined in claim 13, wherein the second connector includes a hook which biases the cable toward the fastener; and wherein the hook includes a terminal end with a detent extending inwardly into a space for receiving a head of the fastener therethrough.

16. The cable assembly as defined in claim 13, wherein the second connector includes a base which engages the first connector, a plate angled relative to the base and extending linearly outwardly therefrom; and a hook extending outwardly from the plate and adapted to engage the head of the fastener and bias the cable toward the fastener.

17. The cable assembly as defined in claim 16, further comprising a corner region provided on the plate; said corner region having an end adapted to be located adjacent the fastener when the fastener is received in a space defined between the corner region and the hook.

18. The cable assembly as defined in claim 17, wherein the corner region is angled relative to the rest of the plate.

19. The cable assembly as defined in claim 13, wherein the first connector is crimped to the first end of the cable to secure the first connector to the cable.

20. The cable assembly as defined in claim 13, wherein the second connector is crimped to the first connector to secure the second connector to the first connector.

21. A method of attaching and tensioning a cable to a structure; said method comprising the steps of:
providing a cable assembly having a first connector and a second connector;
securing the first connector of the cable assembly to a first end of the cable;
securing the second connector to the first connector;
surrounding a first portion of a fastener extending outwardly from the structure with the first connector; and
abutting a second portion of the fastener with the second connector to bias the cable towards the fastener.

22. The method as defined in claim 21, further comprising the step of abutting the second portion of the fastener with a biasing member of the second connector to bias the cable towards the fastener.

23. The method as defined in claim 22, further comprising the step of forming the biasing member in the shape of a hook.

24. The method as defined in claim 21, further comprising the step of defining an aperture in the first connector and disposing the first portion of the fastener in the aperture to surround the first portion of the fastener with the first connector.

25. The method as defined in claim 21, further comprising the step of frictionally engaging or crimping the first connector onto the cable to secure the first connector to the cable.

26. The method as defined in claim 21, further comprising the step of crimping the second connector onto the first connector to secure the second connector to the first connector.
